(19) United States
(12) Patent Application Publication
(10) Pub. No.: US 2024/0397905 A1
(43) Pub. Date: Dec. 5, 2024

(54) TURN-AROUND FARROWING CRATE

(71) Applicant: Osborne Industries, Inc., Osborne, KS (US)

(72) Inventor: George R Eakin, Osborne, KS (US)

(21) Appl. No.: 18/735,034

(22) Filed: Jun. 5, 2024

Related U.S. Application Data
(63) Continuation of application No. 63/471,211, filed on Jun. 5, 2023.

(51) Int. Cl. A01K 1/02

(52) U.S. Cl. CPC A01K 1/0218

(57) ABSTRACT

A farrowing crate has front and rear wall assemblies and first and second sidewalls that extend between the front and rear wall assemblies. The sidewalls have arcuate lower edges supported above a floor to allow piglets to pass thereunder, and outwardly bowed middle portions. The arcuate lower edges of the sidewalls are spaced apart a sufficient distance from each other to accommodate a sow's legs to allow the sow to turn around in the crate. The outwardly bowed middle portions are spaced apart from each other a sufficient distance to accommodate a sow's head and rear end to allow the sow to turn around in the crate. The sidewalls have straight upper edges that are spaced apart approximately the same width as the front and rear wall assemblies to provide open access into the top of the crate while discouraging a sow from attempting to climb out of the crate.

### RELATED APPLICATIONS

This application claims the benefit of U.S. Provisional Patent Application No. 63/471,211 filed on Jun. 5, 2023. The entire content of this related application is incorporated herein by reference.

### BACKGROUND OF THE INVENTION

### Field of the Invention

The present invention relates generally to livestock confinement structures, and in particular, to farrowing crates for pig production facilities.

### Description of the Related Art

A conventional farrowing crate for pigs is illustrated in FIG. 7. The conventional farrowing crate is made of metal bars and located within a pen where pregnant sows are placed before giving birth. The conventional farrowing crate has a rear panel that can be opened to allow the sow to enter the crate, and a front panel with a feeder.

The conventional crate is sufficiently narrow to prevent the sow from turning around within the crate. After the sow gives birth within the crate, she remains within the crate until the piglets are ready to be weaned. A creep area is located alongside the crate for the piglets to lie down away from the sow. When the piglets are ready to be weaned, the front panel of the crate is opened to allow the sow to exit from the crate.

There is a need in the industry for a farrowing crate that improves the comfort and reduces stress on sows, while maintaining a safe environment for piglets.

### SUMMARY OF THE INVENTION

An object of the present invention is to provide a farrowing crate that satisfies industry and regulatory demands for increased space and comfort for pigs raised in confinement facilities.

A further object of the present invention is to provide a farrowing crate that allows a sow to turn around within the crate while minimizing stress and injuries to the sow and her piglets.

A further object of the present invention is to provide a farrowing crate that provides an efficient use of space within a confinement facility.

These and other objects of the present invention are accomplished by a farrowing crate that has front and rear wall assemblies and first and second sidewalls that extend between the front and rear wall assemblies. The sidewalls have arcuate lower edges supported above a floor to allow piglets to pass thereunder, and outwardly bowed middle portions. The arcuate lower edges of the sidewalls are spaced apart a sufficient distance from each other to accommodate a sow's legs to allow the sow to turn around in the crate. The outwardly bowed middle portions are spaced apart from each other a sufficient distance to accommodate a sow's head and rear end to allow the sow to turn around in the crate. The sidewalls have straight upper edges that are spaced apart approximately the same width as the front and rear wall assemblies to provide open access into the top of the crate while discouraging a sow from attempting to climb out of the crate.

According to one aspect of the present invention, a farrowing crate is provided, comprising: a front wall assembly comprising a front panel moveable between open and closed positions; a rear wall assembly comprising a rear panel moveable between open and closed positions; and first and second sidewalls that extend between respective sides of the front and rear wall assemblies. The first and second sidewalls each have a front end attached to the front wall assembly, a rear end attached to the rear wall assembly, an arcuate lower edge, a straight upper edge, and an outwardly bowed middle portion. The arcuate lower edges are elevated above a floor to allow piglets to pass thereunder and have a sufficiently wide shape to accommodate a sow's legs when the sow turns around in the crate. The outwardly bowed middle portion has a sufficiently wide shape to accommodate a sow's head and rear end when the sow turns around in the crate. The straight upper edge provides an opening to allow access to the sow by a producer while discouraging the sow from attempting to climb out of the crate.

According to another aspect of the present invention, a farrowing crate is provided, comprising: a front wall assembly with a feeder; a rear wall assembly; and first and second sidewalls that extend between respective sides of the front and rear wall assemblies. The first and second sidewalls each have a front end attached to the front wall assembly, a rear end attached to the rear wall assembly, an arcuate lower edge supported above a floor to allow piglets to pass thereunder, and an outwardly bowed middle portion comprising a thin-walled plastic structure. The arcuate lower edges of the first and second sidewalls are spaced apart from each other a first distance at the front and rear ends and a second distance at an intermediate point between the front and rear ends, the second distance being substantially greater than the first distance to accommodate a sow's legs to allow the sow to turn around in the crate. The outwardly bowed middle portions are spaced apart from each other a third distance at a mid point of the crate between the front and rear ends, the third distance being substantially greater than the second distance to accommodate a sow's head and rear end to allow the sow to turn around in the crate.

Numerous other objects of the present invention will be apparent to those skilled in this art from the following description wherein there is shown and described an embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings.

In the drawings:

FIG. 1 is a top perspective view of a farrowing crate according to the present invention.

FIG. 2 is a top plan view of the farrowing crate.

FIG. 3 is a right side elevational view of the farrowing crate.

FIG. 4 is a left side elevational view of the farrowing crate.

FIG. 5 is a front end view of the farrowing crate.

FIG. 6 is a bottom plan view of the farrowing crate.

FIG. 7 is a perspective view of a conventional farrowing crate.

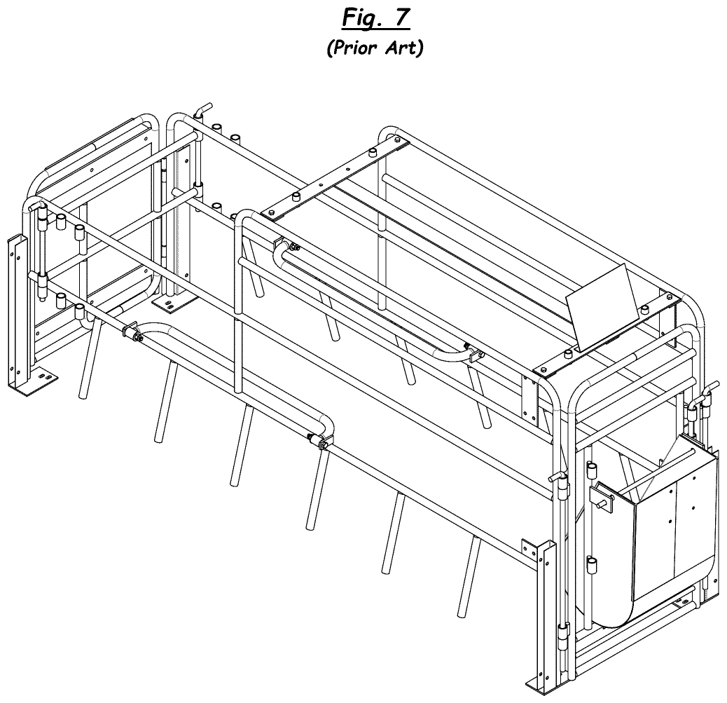

### DETAILED DESCRIPTION OF THE INVENTION

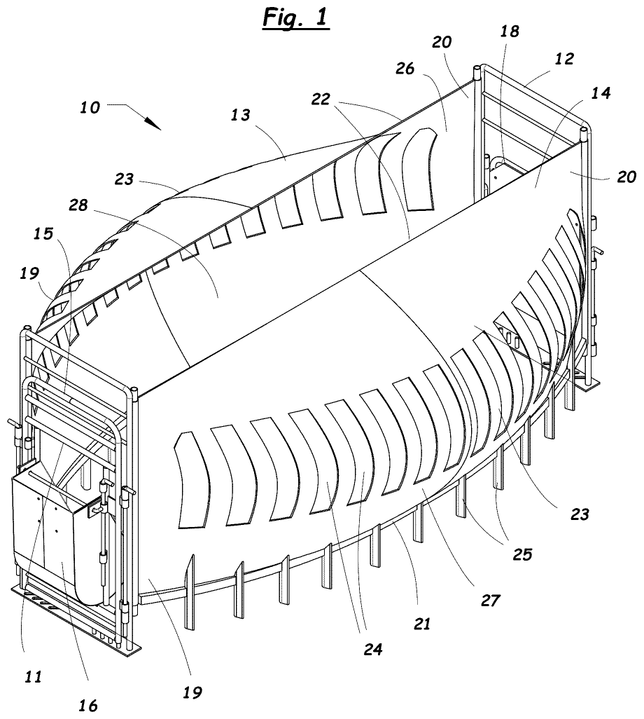

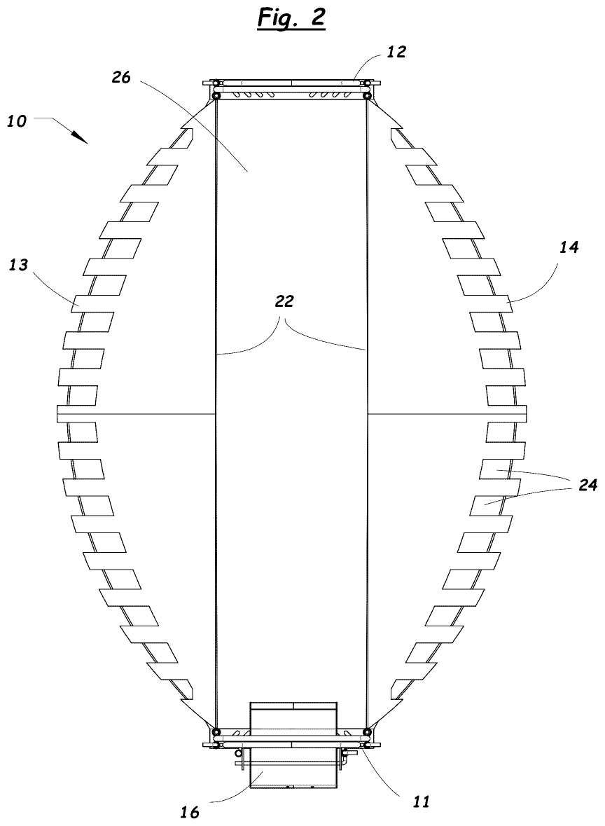

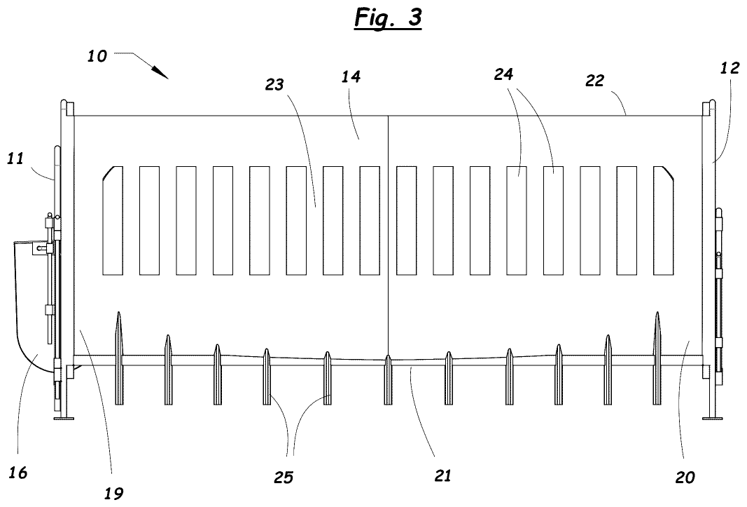

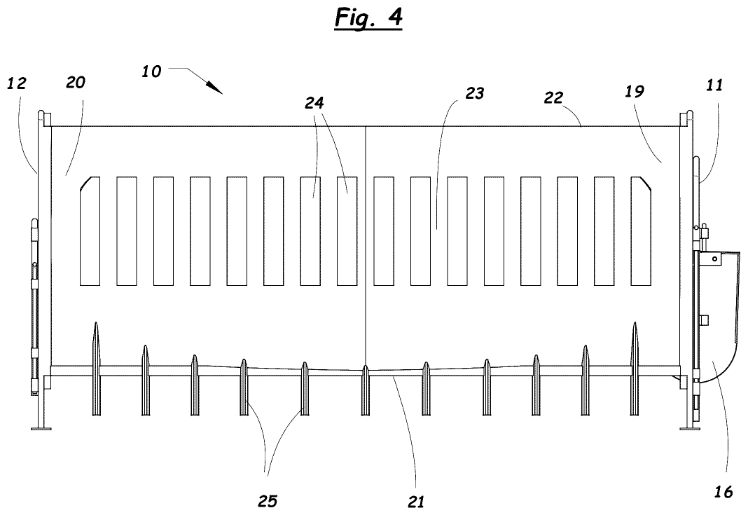

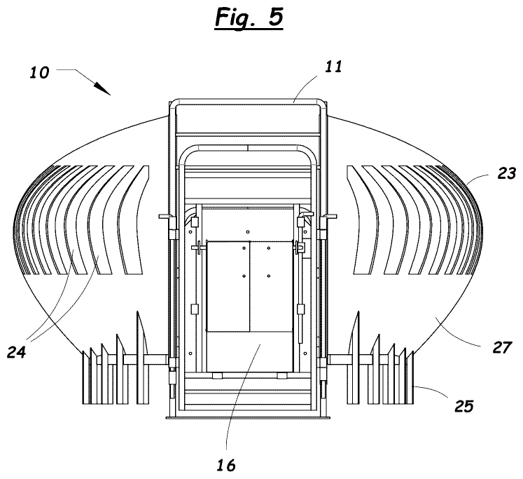

A turn-around farrowing crate 10 according to the present invention will now be explained in detail with reference to FIGS. 1 to 6 of the accompanying drawings.

The farrowing crate 10 has a front wall assembly 11, a rear wall assembly 12, and first and second sidewalls 13, 14. The front wall assembly 11 has a front panel 15 moveable between open and closed positions to allow a sow to exit from the crate 10. A feeder trough 16 is also attached to the front panel 15. The front panel 15 with the feeder trough 16 can be the same as used in the conventional farrowing crate.

The rear wall assembly 12 has a rear panel 18 moveable between open and closed positions. The rear panel 18 can be moved to its open position to allow a sow to enter into the crate 10, and then moved to its closed position to keep the sow confined within the crate 10.

The first and second sidewalls 13, 14 extend between respective sides of the front and rear wall assemblies 11, 12. The sidewalls 13, 14 each have a front end 19 attached to the front wall assembly 11, a rear end 20 attached to the rear wall assembly 12, an arcuate lower edge 21, a straight upper edge 22, and an outwardly bowed middle portion 23.

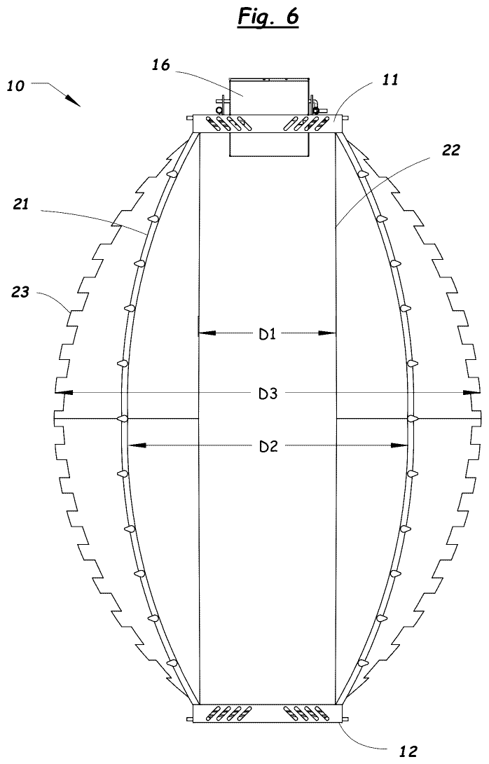

The sidewalls 13, 14 have a generally oval shape in plan view. As shown in bottom plan view in FIG. 6, the outwardly bowed middle portions 23 of the sidewalls 13, 14 form a larger oval shape than the arcuate lower edges 21 of the sidewalls 13, 14. The oval shape provides adequate spacing at the bottom of the sidewalls 13, 14 between the arcuate lower edges 21 to accommodate the distance between the front of an animal's front legs and the back of the animal's rear legs when the animal is standing in the crate 10. The oval shape also provides adequate spacing at the middle of the sidewalls 13, 14 between the outwardly bowed middle portions 23 to accommodate the distance between the animal's head and rear end. The oval shape thus allows the animal to completely turn around within the crate 10 for improved comfort and reduced stress.

A plurality of slots 24 are provided in the sidewalls 13, 14 to improve airflow and reduce stress on the sow. The slots 24 extend generally vertically and are spaced along each of the sidewalls 13, 14 from the front end 19 to the rear end 20.

The sidewalls 13, 14 can be thin-walled plastic structures with smooth inside surfaces to improve comfort and reduce injuries to the sow. For example, the sidewalls 13, 14 can be formed by liquid molding of thermoset plastics using known processes, such as resin transfer molding (RTM) or reaction injection molding (RIM).

The arcuate lower edges 21 of the sidewalls 13, 14 are elevated above the floor to allow piglets to pass thereunder into a creep area surrounding the crate 10. A plurality of vertical supports 25 extend between the arcuate lower edges 21 and the floor to support the sidewalls 13, 14 above the floor.

The arcuate lower edges 21 of the sidewalls 13, 14 are spaced apart from each other a first distance D1 at the front and rear ends 19, 20, and a second distance D2 at an intermediate point between the front and rear ends 19, 20. The second distance D2 is substantially greater than the first distance D1 and sufficiently wide to accommodate a sow's front and rear legs to allow the sow to turn around in the crate 10.

For example, the arcuate lower edges 21 can be spaced apart from each other 20 to 30 inches at their narrowest point (the first distance D1), and 42 to 54 inches at their widest point (the second distance D2). In one working example, the arcuate lower edges are spaced apart from each other approximately 48 inches at the widest point between the front and rear ends 19, 20 of the sidewalls 13, 14. These dimensions are based on the size of a typical sow having a distance from the front of the sow's front legs to the back of the sow's rear legs that would allow the sow to turn around within the dimensions of the widest point of the arcuate lower edges 21 of the crate 10. The preferred dimensions can be changed to accommodate different animal sizes.

The outwardly bowed middle portions 23 of the sidewalls 13, 14 are spaced apart from each other a third distance D3 at a mid point of the crate 10 between the front and rear ends 19, 20. The third distance D3 is substantially greater than the second distance D2 and sufficiently wide to accommodate a sow's head and rear end to allow the sow to turn around in the crate 10.

For example, the outwardly bowed middle portions 23 can be spaced apart from each other 20 to 30 inches at their narrowest point (the first distance D1) and 64 to 80 inches at their widest point (the third distance D3). In one working example, the outwardly bowed middle portions 23 are spaced apart from each other approximately 72 inches at the widest point between the front and rear ends of the sidewalls 13, 14. These dimensions are based on the size of a typical sow having a distance from the front of the snout to the rear of the buttocks that would allow the sow to turn around within the dimensions of the widest point of the outwardly bowed middle portions 23.

The straight upper edges 22 define an opening 26 in the top of the crate to allow access to the sow by a producer. The straight upper edges 22 of the sidewalls 13, 14 are spaced apart a substantially constant distance from the front ends 19 to the rear ends 20. The substantially constant distance is approximately equal to the first distance D1 between the ends 19, 20 of the sidewalls 13, 14. The straight upper edges 22 and relatively narrow configuration of the top opening 26 discourages the sow from attempting to climb out of the crate 10. For example, the straight upper edges 22 of the sidewalls 13, 14 can be spaced apart from each other 20 to 30 inches along the entire length of the crate 10, and preferably approximately 24 inches.

The lower portions 27 of the sidewalls 13, 14 slope downwardly and inwardly toward a center of the crate 10, thereby providing a surface 28 for a sow to slide down slowly and gently when laying down within the crate 10. The sloping inner surfaces 28 of the sidewalls 13, 14 will help minimize instances of the sow flopping down and crushing baby piglets.

While the invention has been specifically described in connection with specific embodiments thereof, it is to be understood that this is by way of illustration and not of limitation, and the scope of the appended claims should be construed as broadly as the prior art will permit.

What is claimed is:

1. A farrowing crate, comprising:
a front wall assembly comprising a front panel moveable between open and closed positions;
a rear wall assembly comprising a rear panel moveable between open and closed positions; and
first and second sidewalls that extend between respective sides of the front and rear wall assemblies;
wherein said first and second sidewalls each have a front end attached to the front wall assembly, a rear end attached to the rear wall assembly, an arcuate lower edge, a straight upper edge, and an outwardly bowed middle portion, said arcuate lower edges being elevated above a floor to allow piglets to pass thereunder and having a sufficiently wide shape to accommodate a sow's legs when the sow turns around in the crate, said outwardly bowed middle portion having a sufficiently wide shape to accommodate a sow's head and rear end when the sow turns around in the crate, and said straight upper edge providing an opening to allow access to the sow by a producer while discouraging the sow from attempting to climb out of the crate.

2. The farrowing crate according to claim 1, wherein said front wall assembly further comprises a feeder.

3. The farrowing crate according to claim 1, further comprising a plurality of vertical supports extending between the arcuate lower edges and the floor to support the first and second sidewalls above the floor.

4. The farrowing crate according to claim 1, wherein said first and second sidewalls are thin-walled plastic structures.

5. The farrowing crate according to claim 1, wherein said first and second sidewalls each have a plurality of slots for enhanced airflow and visibility.

6. The farrowing crate according to claim 5, wherein said plurality of slots extend generally vertically and are spaced along each of said sidewalls from said front end to said rear end.

7. The farrowing crate according to claim 1, wherein the arcuate lower edges of said first and second sidewalls are spaced apart from each other 20 to 30 inches at their narrowest point, and are spaced apart from each other 42 to 54 inches at their widest point to accommodate a sow's legs when the sow turns around in the crate.

8. The farrowing crate according to claim 1, wherein the arcuate lower edges of said first and second sidewalls are spaced apart approximately 48 inches at an intermediate point between the front and rear ends to accommodate a sow's legs when the sow turns around in the crate.

9. The farrowing crate according to claim 1, wherein the outwardly bowed middle portions of the first and second sidewalls are spaced apart from each other 20 to 30 inches at their narrowest point, and are spaced apart from each other 64 to 80 inches at their widest point to accommodate a sow's head and rear end when the sow turns around in the crate.

10. The farrowing crate according to claim 1, wherein the outwardly bowed middle portions of the first and second sidewalls are spaced apart approximately 72 inches at an intermediate point between the front and rear ends to accommodate a sow's head and rear end when the sow turns around in the crate.

11. The farrowing crate according to claim 1, wherein the straight upper edges of the first and second sidewalls are spaced apart a substantially constant distance from the front ends to the rear ends to provide an open top for allowing access by a producer while discouraging a sow from attempting to climb out of the crate.

12. The farrowing crate according to claim 1, wherein the straight upper edges of the first and second sidewalls are spaced apart from each other approximately 24 inches along an entire length of the crate.

13. The farrowing crate according to claim 1, wherein lower halves of the first and second sidewalls slope downwardly and inwardly toward a center of the crate, thereby providing a surface for a sow to slide down instead of flopping down and crushing baby piglets.

14. A farrowing crate, comprising:
a front wall assembly with a feeder;
a rear wall assembly; and
first and second sidewalls that extend between respective sides of the front and rear wall assemblies;
wherein said first and second sidewalls each have a front end attached to the front wall assembly, a rear end attached to the rear wall assembly, an arcuate lower edge supported above a floor to allow piglets to pass thereunder, and an outwardly bowed middle portion comprising a thin-walled plastic structure;
said arcuate lower edges of the first and second sidewalls are spaced apart from each other a first distance at the front and rear ends and a second distance at an intermediate point between the front and rear ends, said second distance being substantially greater than said first distance to accommodate a sow's legs to allow the sow to turn around in the crate; and
said outwardly bowed middle portions are spaced apart from each other a third distance at a mid point of the crate between the front and rear ends, said third distance being substantially greater than said second distance to accommodate a sow's head and rear end to allow the sow to turn around in the crate.

15. The farrowing crate according to claim 14, wherein said first and second sidewalls have straight upper edges that are spaced apart a substantially constant distance along a length of the crate to provide open access into the crate for a producer while discouraging a sow from attempting to climb out of the crate.

16. The farrowing crate according to claim 15, wherein said substantially constant distance is approximately equal to said first distance.

17. The farrowing crate according to claim 14, wherein said first distance is approximately 24 inches, said second distance is approximately 48 inches, and said third distance is approximately 72 inches.

18. The farrowing crate according to claim 14, wherein said first distance is 20 to 30 inches, said second distance is 42 to 54 inches, and said third distance is 64 to 80 inches.

19. The farrowing crate according to claim 14, wherein said first and second sidewalls each have a plurality of vertical slots.

20. The farrowing crate according to claim 14, wherein lower halves of the first and second sidewalls slope downwardly and inwardly toward a center of the crate, thereby providing a surface for a sow to slide down instead of flopping down and crushing baby piglets.
